(19) United States
(12) Patent Application Publication
(10) Pub. No.: US 2004/0230669 A1
(43) Pub. Date: Nov. 18, 2004

(54) Delivery of unlimited data with a limited bandwidth in a data delivery system

(76) Inventor: Jin Teik Teh, Los Altos, CA (US)

Correspondence Address: Jason Z. LIN, Supreme Patent Services, Post Office Box 2339, Saratoga, CA, 95070-0339, US

(21) Appl. No.: 10/440,380

(22) Filed: May 17, 2003

(51) Int. Cl. G06F 15/16; G06F 15/167

(52) U.S. Cl. 709/219; 709/213

(57) ABSTRACT

The present invention takes advantage of a data hosting service available in a data delivery system. The data hosting server can be designed as an application server that hosts only personal information of the users, but not the public contents that need to be purchased by the user. As all requests from the users to read from or write to the personal information must be made through the data hosting server, the other application servers of the system can focus on serving the paid functions for application subscribers. As all the users' data are hosted on the server, users do no need to send the entire data when they wish to transfer the data to another user. Instead, users only need to send a request with ID for intended data informing the system, or more specific, the data hosting server, to send the hosted copy of the data to the target user.

### FIELD OF THE INVENTION

This invention relates to a method of data delivery in a data delivery system, and more particularly to a method for delivering unlimited data with a limited bandwidth in a data delivery system.

### BACKGROUND OF THE INVENTION

Due to the rapid progress in the wired and wireless communication, more and more data delivery systems are developed to provide users of mobile devices the access to a wide range of applications and data. These systems aim to provide users with a seamless and easy access to various applications and data on a subscription basis. As the number of users of the system increases, many methods are proposed to alleviate data delivery loading and to improve the system performance. A data hosting server is an application server for this purpose. It provides hosting services for information such as text message, picture messages, emails, phonebook records, uploaded image and audio files, stock portfolios and subscription information.

FIG. 1 shows a wireless data delivery system where the present invention is applicable. The system 101 comprises a platform client 102, and a platform server 103. The platform client 102 is responsible for interfacing with various clients, such as a mobile phone 110, a PDA 111, or a notebook computer 112; and the platform server 103 provides interface to various application servers 121. When a wireless client 110, 111, 112 requests for a service from an application, a request message is sent from the client to application server 121. The platform client 102, upon receiving the request message, will relay the request to the platform server 103, then forwarded to targeted application server 121, where the request is processed, and a result message is sent back to the requesting client 110, 111, 112.

Clients in a wireless data delivery system, such as phones 110, personal data assistants 111, and other handheld computing devices 112, usually have a limited bandwidth when connecting to the system. This limited bandwidth imposes a sever limitation when a large amount of data is retrieved from the system or sent from a user to another. In the former situation, they are usually required to download or retrieve the entire data set from a remote application server 121. In the latter, the data need to be sent from the sender to the system, and then routed to the target receiver. As two separate connections to the system is involved in this type of operation, the bandwidth limitation is even more prominent.

### SUMMARY OF THE INVENTION

The present invention takes advantage of a data hosting service available in a data delivery system. The data hosting server can be designed as an application server that hosts only personal information of the users, but not the public contents that need to be purchased by the user. As all requests from the users to read from or write to the personal information must be made through the data hosting server, the other application servers of the system can focus on serving the paid functions for application subscribers. There is an important performance criterion that such a data hosting server must meet. As the major storage requirement is in the data store, a scalable implementation is usually preferable so that it can deliver acceptable performance under high load.

As all the users' data are hosted on the server, users do no need to send the entire data when they wish to transfer the data to another user. Instead, users only need to inform the system, or more specific, the data hosting server, to send the hosted copy of the data to the target user.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a wireless data delivery system where the present invention is applicable.

FIG. 2 shows an internal structure of a data hosting server.

FIG. 3 shows a record format containing information on file-based data.

FIG. 4 shows a record format containing information on record-based data.

### DETAILED DESCRIPTION OF THE INVENTION

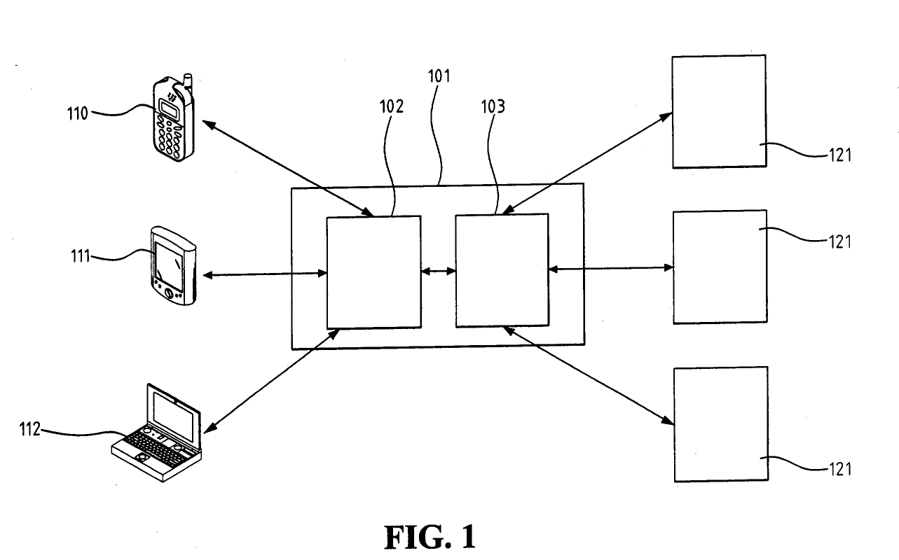

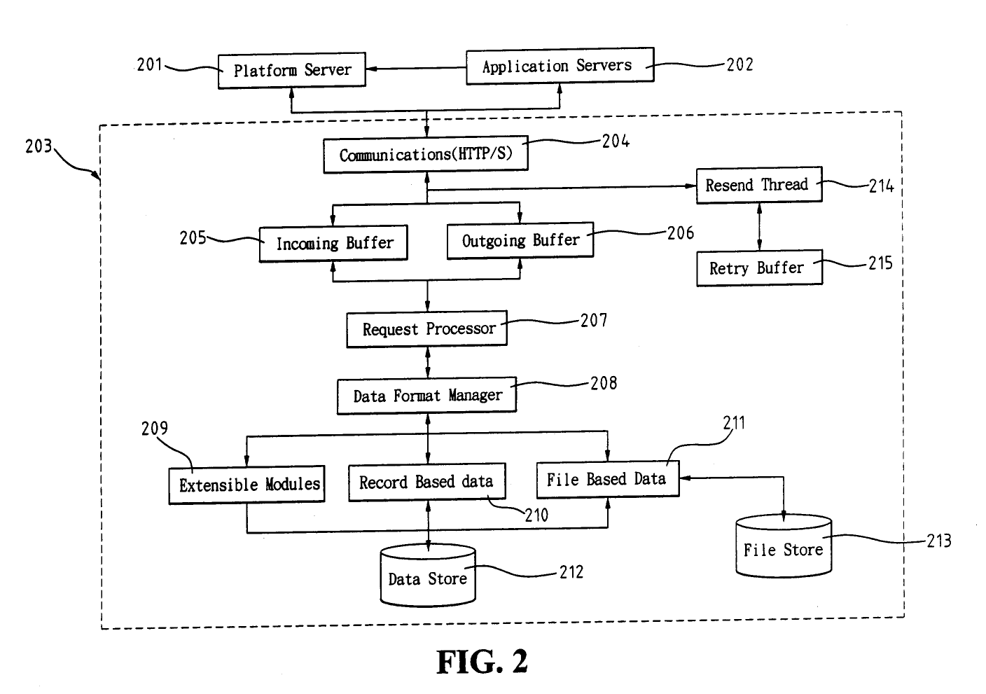

FIG. 2 shows a data delivery system in which a data hosting server 203 is designed as an application server. A pictorial representation of hosting server internal architecture is also shown in FIG. 1. The platform server 201 provides generic functionality for managing all application and data that belong to users. While the application servers 202 are servers that manage all processes and tasks specific to an application or product or service. Application client (not shown) is a separate module or process that resides on the client that provides a specific task for the client, it can be a specialized application that handles drawing of vector graphics or the playing of MP3 audio files, or it can be an application logic client that handles the input and transaction of stock trades. The data hosting server 203 communicates with the platform server 100 like other application servers 202. Furthermore, the data hosting server 203 consists of a request processor 108 that handles all incoming message regarding users' personal data from the platform server 201 and application servers 202 while the application servers 160 are primarily to handle the application control logic and non-personal data. It must be noted that in this invention all read and write from and to personal data must be made through the data hosting server 203.

As shown in FIG. 1, the data hosting server 203 is further comprising a communication module 204, an incoming buffer 205, an outgoing buffer 206, a request processor 207, a data format manager 208 managing an extensible modules 209, a record-based data format 210, and a file-base data format 211, a data store 212, a file store 213 for storing file-based data, a resend thread process 214 and a retry buffer 215 used by the resend thread 214.

The communications module 204 accepts requests from the platform server 201 and application servers 202. It may be implemented to accept, for example, HTTP commands. The incoming buffer 205 stores all incoming messages. When a new message is received in incoming buffer 205, the request process 207 is notified of the new message. On the other hand, the outgoing buffer 206 stores all outgoing message to be sent to the platform server 201 or the application servers 202. When a new message is received in outgoing buffer 206, the communication module 204 is notified.

The request processor 207 handles all incoming and outgoing requests. Incoming messages are passed to the data format manager 208 for processing in accordance with their data type. The application manager 208 manages all the available data format modules in the data hosting server, such as a record-based data format 210 and a file-based data format 211, as well as an extensible module 209 that allows to the data server to add new data format module when necessary. Examples of record based formats 210 are phoneBook records, calendar records and messaging records, and examples of file based formats 211 are photo, audio and multimedia files. The all hosted data are stored in the data store 212, and the file store 213.

The retry buffer 215 stores all outgoing messages that failed to be sent to the application server 202 or platform server 201. The messages will be retried after a preset number of times. The resend thread 214 picks up messages from the retry buffer 215 at specified intervals for resending.

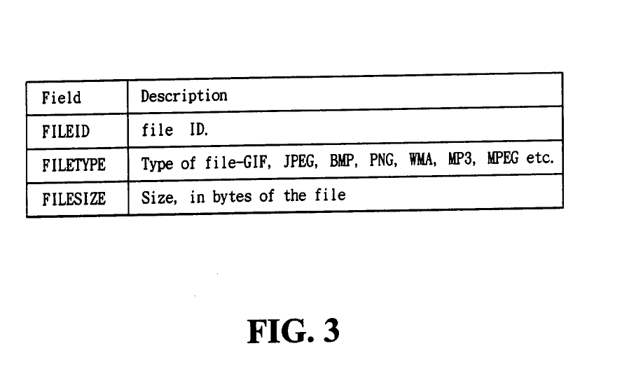

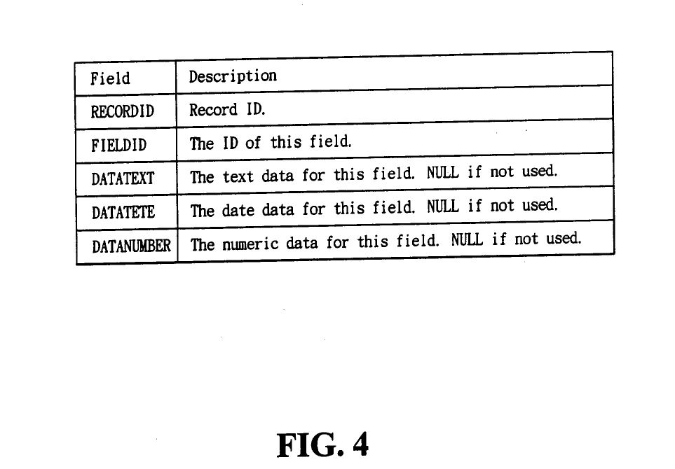

FIG. 3 and FIG. 4 show the record formats for the file-based data and the record-based data of the embodiment of the present invention, respectively. The record for file-based data comprises a FileID field storing file ID, a FileType field indicating type of the file, such as GIF, JPEG, BMP, PNG, WMA, MP3, MPEG, and a FileSize field to indicate the size of the file in bytes. The record for record-based data comprises a RecordID field for storing record ID, a FieldID for storing ID of this field, a DataText field for storing text data for this field, a DataDate field for storing date data for this field, and a DataNumber field for storing numeric data for this field.

The data hosting server provides following operations for storing and retrieving requested data for a client, referring to FIG. 2:

storing requested data, which further comprising the following steps of:

(1). the platform server 201 or application server 202 sending requests,

(2). the requests being received by the communication module 204, and stored in incoming buffer 205,

(3). the request processor 207 receiving requests in incoming buffer 205, interpreting the requests, and calling data format manager 208 using a corresponding data format module to process the storing,

(4). the requested data being stored in either data store 212 or file store 213, a corresponding record is created to store the information on the requested data,

(5). a result message of the storing being generated by the data format manager 208, passed to request processor 207, placed in the outgoing buffer 206, and sent to the requesting platform server 201 or application server 202 through the communication module 204.

retrieving requested data, which further comprising the following steps of:

(1). the platform server 201 or application server 202 sending requests,

(2). the requests being received by the communication module 204, and stored in incoming buffer 205,

(3). the request processor 207 receiving requests in incoming buffer 205, interpreting the requests, and calling data format manager 208 to find the requested data in either data store 212 or file store2l3, and

(4). the requested data being retrieved by the data format manager 208, passed to request processor 207, placed in the outgoing buffer 206, and sent to the requesting platform server 201 or application server 202 through the communication module 204.

resending results, performed when the first sending to the platform server 201 or the application server 202 is unsuccessful, further comprising:

(1). the outgoing messages being re-directed to the retry buffer 215,

(2). the resend thread 215 picking up messages from the retry buffer 215 at specified intervals and resending.

Referring to FIG. 1 again, when users request the data delivery system to send their data to another user, they do not need to send the data from their devices 110, 111, 112 to the platform server. Instead, they can send a request containing only the ID to indicate the data to the system. Upon receiving the request, the platform server passes the request to the data hosting server, which will retrieve the data with the ID, and send the data to the intended users or devices 110, 111, 112. Because the requests containing ID for the data usually takes up only a few bytes, or tens of bytes, the present invention allows the users to send requests even when the bandwidth of the connection to the system is limited.

While we have shown and described the embodiment in accordance with the present invention, it should be clear to those skilled in the art that further embodiments may be made without departing from the scope of the present invention.

What is claimed is:

1. In a data delivery system having a platform server, a plurality of application servers, and implementing a data hosting server as an application server, said data hosting server providing functions of storing or retrieving data on said data hosting server as requested by said platform server or said application server, a means to deliver a large amount of data from a user to another, comprising:
sending a request containing the ID for said data hosted in said data hosting server,
said data hosting server using said ID to locate said data, and delivering said data to intended receiving user.

2. A means claimed as in claim 1, wherein said ID for the data is a file ID indicating the file-based data.

3. A means claimed as in claim 1, wherein said ID for the data is a record ID indicating record-based data.

4. An apparatus used in a data delivery system having a platform server, a plurality of application servers, and implementing a data hosting server as an application server, said data hosting server providing functions of storing or retrieving data on said data hosting server as requested by said platform server or said application server, to deliver a large amount of data from a user to another, said apparatus comprising:
i. a memory storing a program, and
ii. a processor responsive to the said program to:
receive a request containing the ID for said data hosted in said data hosting server,
use said ID to locate said data, and deliver said data to intended receiving user.
